(19) United States
(12) Patent Application Publication
(10) Pub. No.: US 2021/0191441 A1
(43) Pub. Date: Jun. 24, 2021

(54) Constant Voltage Generation Circuit

(71) Applicant: KABUSHIKI KAISHA TOKAI-RIKA-DENKI-SEISAKUSHO, Aichi-ken (JP)

(72) Inventor: Keigo Kagimoto, Aichi-ken (JP)

(73) Assignee: KABUSHIKI KAISHA TOKAI-RIKA-DENKI-SEISAKUSHO

(21) Appl. No.: 17/128,295

(22) Filed: Dec. 21, 2020

(30) Foreign Application Priority Data
Dec. 23, 2019 (JP) 2019-231940

(51) Int. Cl. G05F 1/575

(52) U.S. Cl. CPC G05F 1/575

(57) ABSTRACT

A constant voltage generation circuit is provided. The constant voltage generation circuit includes a differential pair including a first transistor having a gate input with a reference voltage and a second transistor having a gate input with a signal corresponding to an output voltage, an output transistor that has a gate connected to a connection point between a drain of one transistor out of the differential pair and a load of the one transistor and that is configured to output the output voltage, and a diode connected between the gate of the output transistor and a power source.

### CROSS-REFERENCE TO RELATED APPLICATION

This application is based on and claims priority under 35 USC 119 from Japanese Patent Application No. 2019-231940 filed on Dec. 23, 2019, the disclosure of which is incorporated by reference herein.

### BACKGROUND

### Technical Field

The present disclosure relates to a constant voltage generation circuit.

A phenomenon generally referred to as overshoot sometimes occurs in electronic circuits including a constant voltage generation circuit. Overshoot is a phenomenon in which the rising flank of a square waveform overruns a reference line corresponding to the waveform when at a steady value. Conversely, undershoot is a phenomenon in which the falling flank of a square waveform overruns the reference line corresponding to the waveform when at a steady value. A voltage regulator disclosed in Japanese Patent Application Laid-Open (JP-A) No. 2015-138394 is a known example of prior art addressing overshoot occurring in a constant voltage generation circuit. The voltage regulator according to JP-A No. 2015-138394 includes an error amplifier circuit that amplifies and outputs a difference between a divided voltage obtained by dividing an output voltage output by an output transistor, and a reference voltage output by a reference voltage circuit, and that controls a gate of the output transistor. The error amplifier circuit includes an input transistor having a gate input with the divided voltage, and a diode having a cathode connected to a source of the input transistor and an anode connected to the gate of the input transistor. In JP-A No. 2015-138394, providing the diode enables the destruction of the gate of the input transistor to be prevented even if overshoot occurs in an output terminal.

An overshoot suppression circuit disclosed in JP-A No. 2016-157231 is a known overshoot suppression circuit provided to a power source circuit. The overshoot suppression circuit according to JP-A No. 2016-157231 includes a pnp-type or a P channel-type first transistor that is provided between an input terminal for a power source voltage and a gate or a base of an output transistor, a base or a gate of the first transistor being connected to the input terminal for the power source voltage through a first resistor. The first transistor serves to suppress overshoot of an output voltage by being connected to the P channel-type or pnp-type output transistor that is provided between the input terminal of the power source voltage and an output terminal of the output voltage. The overshoot suppression circuit in JP-A No. 2016-157231 enables an overshoot suppression circuit with a smaller circuit size to be realized.

FIG. 2A illustrates a constant voltage generation circuit 100 according to prior art that employs a similar configuration to the voltage regulator according to JP-A No. 2015-138394. As illustrated in FIG. 2A, the constant voltage generation circuit 100 is configured including N-type metal oxide semiconductor (MOS) transistors QN11, QN12, P-type MOS transistors QP11, QP12, and a current source 101 configuring a differential pair, a P-type MOS transistor QP13 configuring an output transistor, and resistors R11, R12. A reference voltage Vref is input to a gate of the N-type MOS transistor QN11, and a voltage divided by the resistors R11 and R12 is input as a feedback voltage VB to a gate of the N-type MOS transistor QN12. In the constant voltage generation circuit 100 with the above configuration, an output voltage Vout is controlled based on the reference voltage Vref by controlling feedback based on the feedback voltage VB. The output voltage Vout of the constant voltage generation circuit 100 is thereby maintained at a constant voltage.

However, in the constant voltage generation circuit 100, overshoot may occur in an operating waveform when for example a power source is powering up (on start-up). Explanation follows regarding such overshoot occurrence, with reference to FIG. 2B.

If power source voltage rises rapidly when a power source voltage Vp is switched on, since a gate voltage Vg of the P-type MOS transistor QP13 configuring the output transistor rises from 0V, operation starts from a state in which a gate-source voltage Vgs of the P-type MOS transistor QP13 is in a substantially fully open state (a state in which the gate-source voltage Vgs is close to maximum). An error voltage at the gate of the P-type MOS transistor QP13 is then superimposed based on the feedback voltage VB, and the gate-source voltage Vgs of the P-type MOS transistor QP13 transitions in a closing direction (a direction in which the gate-source voltage Vgs decreases). In the constant voltage generation circuit 100, feedback is controlled based on the above operation such that the output voltage Vout becomes a constant voltage.

However, in practice, in the constant voltage generation circuit 100, there is a delay in the feedback operation. Moreover, as described above, in the constant voltage generation circuit 100 operation starts from a state in which the gate-source voltage Vgs of the P-type MOS transistor QP13 configuring the output transistor is fully open, namely from a state in which a large current is able to flow. Thus, an excessive output current flows even after the output voltage Vout has reached its target voltage (a voltage based on the reference voltage Vref). This causes overshoot to occur in the output voltage Vout.

More detailed explanation follows regarding this overshoot occurrence, with reference to FIG. 2B. FIG. 2B illustrates waveforms of the gate voltage Vg of the P-type MOS transistor QP13 and the output voltage Vout as the power source voltage Vp rises. The gate voltage Vg starts from 0V and the output voltage Vout increases to follow the gate voltage Vg accompanying a steep rise in the power source voltage. The gate voltage Vg follows, but maintains an excessively low voltage with respect to the power source voltage Vp, thus allowing a large current to flow in the P-type MOS transistor QP13 (see the period T1).

Even when the output voltage Vout reaches the target voltage, excessive current commensurate with the delay in the feedback operation is supplied, such that the output voltage Vout exceeds fluctuates by more than a target value (see the period T2). This operation may result in overshoot of the output voltage Vout occurring accompanying the rise of the power source voltage Vp in the constant voltage generation circuit 100. If overshoot occurs in the output voltage Vout, overshoot also occurs in the gate voltage Vg. The occurrence of such overshoot could cause damage to circuit elements in the constant voltage generation circuit 100, and so control is required to prevent such overshoot as much as possible.

### SUMMARY

In consideration of the above circumstances, an exemplary embodiment of the present disclosure relates to providing a constant voltage generation circuit that suppresses the occurrence of overshoot accompanying operation of a circuit.

A constant voltage generation circuit according to a first aspect of the present disclosure includes a differential pair including a first transistor having a gate input with a reference voltage and a second transistor having a gate input with a signal corresponding to an output voltage, an output transistor having a gate connected to a connection point between a drain of one transistor of the differential pair and a load of the one transistor and configured to output the output voltage, and a diode connected between the gate of the output transistor and a power source.

In the constant voltage generation circuit according to the first aspect, the diode connected between the gate of the output transistor and the power source clamps the gate voltage of the output transistor, thereby suppressing the occurrence of overshoot accompanying circuit operation.

A constant voltage generation circuit according to a second aspect of the present disclosure further includes a third transistor having a drain with common connection to a drain of the first transistor and configuring the load of the one transistor, and a fourth transistor having a gate and a drain connected together with the drain also having a common connection to a drain of the second transistor. The gate of the output transistor is connected to a connection point between the first transistor and the third transistor.

The constant voltage generation circuit according to the second aspect further includes the third transistor having a drain with common connection to a drain of the first transistor and configuring the load of the one transistor, and the fourth transistor having a gate and a drain connected together with the drain also having a common connection to the drain of the second transistor. The gate of the output transistor is connected to the connection point of the first transistor to the third transistor, thereby configuring an amplifier circuit. This enables an amplifier circuit for constant voltage generation to be configured simply.

A constant voltage generation circuit according to a third aspect and a fourth aspect of the present disclosure further includes plural of diodes, wherein a number of the plural diodes is set within a range in which a total forward voltage of the plural diodes is greater than a potential difference between the power source and the gate of the output transistor.

In the constant voltage generation circuit according to the third aspect and the fourth aspect, the number of the plural diodes is set within the range in which the total forward voltage of the plural diodes is greater than the potential difference between the power source and the gate of the output transistor. Accordingly, power does not pass through the diodes during normal operation of the constant voltage generation circuit. The plural diodes therefore do not affect operation of the constant voltage generation circuit.

The present disclosure exhibits the excellent advantageous effect of being capable of providing a constant voltage generation circuit that suppresses the occurrence of overshoot accompanying circuit operation.

### BRIEF DESCRIPTION OF DRAWINGS

FIG. 1A is a circuit diagram illustrating an example of configuration of a constant voltage generation circuit according to an exemplary embodiment of the present disclosure;

FIG. 1B is a timing chart illustrating operation waveforms of respective elements of a constant voltage generation circuit according to an exemplary embodiment of the present disclosure;

FIG. 2A is a circuit diagram illustrating an example of configuration of a constant voltage generation circuit according to prior art; and

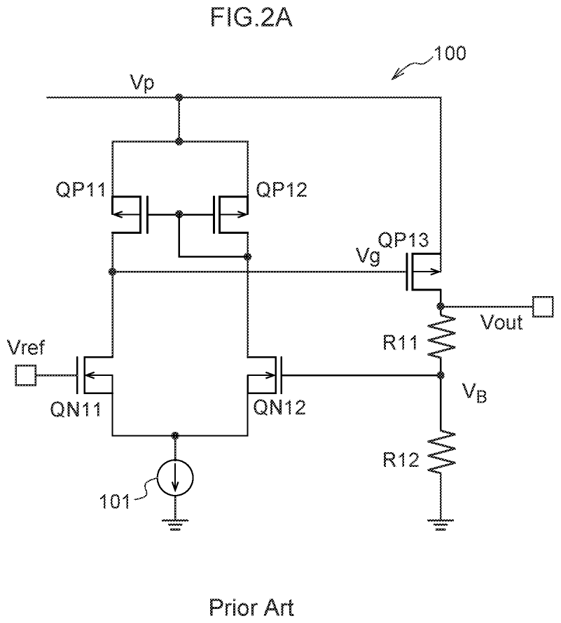

FIG. 2B is a timing chart illustrating operation waveforms of respective elements of a constant voltage generation circuit according to prior art.

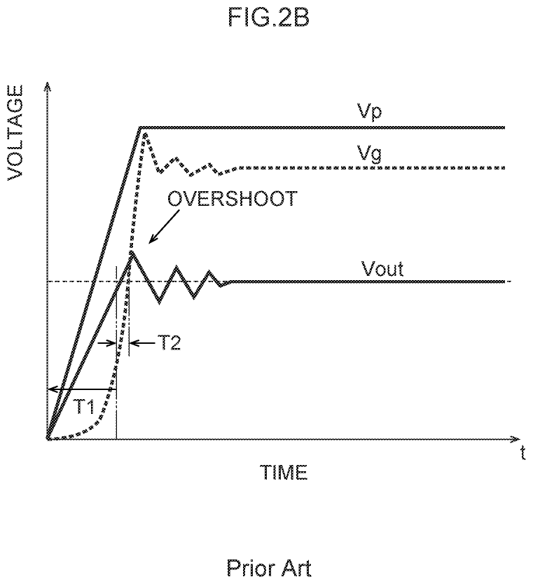

### DETAILED DESCRIPTION

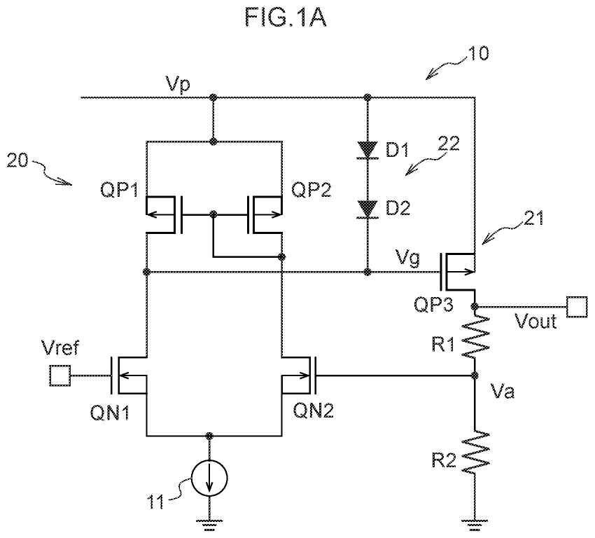

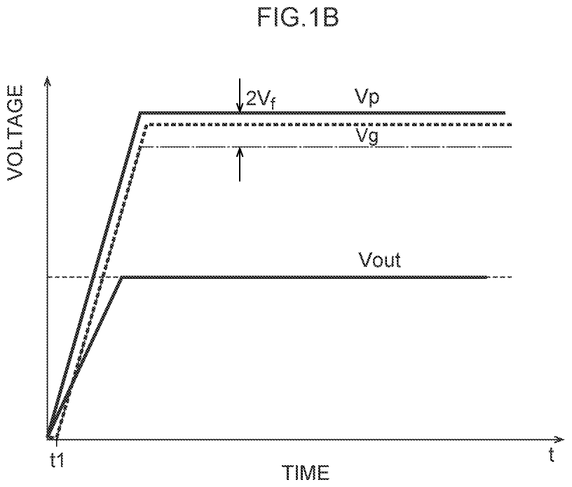

Detailed explanation follows regarding a constant voltage generation circuit according to an exemplary embodiment of the present disclosure, with reference to FIG. 1.

As illustrated in FIG. 1A, a constant voltage generation circuit 10 according to the present exemplary embodiment is configured including N-type MOS transistors QN1, QN2, P-type MOS transistors QP1, QP2, QP3, resistors R1, R2, a current source 11, and diodes D1, D2. The constant voltage generation circuit 10 is a regulator circuit that for example steps down a 12V power source voltage Vp to 3.3V to be output as an output voltage Vout.

An example of configuration of a constant voltage generation circuit (regulator circuit) is a circuit combining a reference voltage generation circuit that generates a high precision reference voltage Vref, and an amplifier circuit that amplifies the reference voltage Vref to the target output voltage Vout to be supplied to a later stage circuit. In particular, a constant voltage needs to be maintained while supplying sufficient current to the later stage circuit at an output stage of the amplifier circuit, and so a single stage P-type MOS transistor with a large transistor size and open drain output is often employed therefor.

The constant voltage generation circuit 10 according to the present exemplary embodiment adopts the above configuration. FIG. 1A illustrates the amplifier circuit and the output stage of the above configuration. The reference voltage generation circuit is not directly relevant to the present disclosure and so illustration thereof is omitted. However, the output of the reference voltage generation circuit is connected to the terminal denoted Vref in FIG. 1A.

In FIG. 1A, the N-type MOS transistors QN1, QN2 and the current source 11 configure a differential pair. The P-type MOS transistor QP1 configures the load of the N-type MOS transistor QN1, and the P-type MOS transistor QP2 configures the load of the N-type MOS transistor QN2 to configure an amplifier circuit 20 as described above. The P-type MOS transistor QP3 and the resistors R1, R2 configure an output stage 21 as described above. The constant voltage generation circuit 10 also includes an overshoot suppression circuit 22 for suppressing the overshoot described earlier. The overshoot suppression circuit 22 is configured including the diodes D1, D2.

The reference voltage Vref is input to a gate of the N-type MOS transistor QN1 of the amplifier circuit 20, and a feedback voltage Va is input to a gate of the N-type MOS transistor QN2. The feedback voltage Va is a voltage that is divided from the output voltage Vout by the resistor R1 and resistor R2 that are connected to a drain of the P-type MOS transistor QP3. The feedback voltage Va is compared against the reference voltage Vref, and a comparison result difference is applied to a gate of the P-type MOS transistor QP3 as an error voltage, so as to maintain the output voltage Vout at a constant voltage value based on the reference voltage Vref.

Next, explanation follows regarding operation of the overshoot suppression circuit 22, with reference to FIG. 1B. FIG. 1B illustrates operating waveforms of the power source voltage Vp, a gate voltage Vg of the P-type MOS transistor QP3, and the output voltage Vout accompanying start-up of a power source.

The diodes D1, D2 configuring the overshoot suppression circuit 22 are connected between the power source voltage Vp and the gate of the P-type MOS transistor QP3 in the orientation illustrated in FIG. 1A. The diodes D1, D2 suppress the gate voltage Vg of the P-type MOS transistor QP3 configuring an output transistor from diverging (falling behind) excessively in response to a steep rise in the power source voltage Vp. As illustrated in FIG. 1B, as well as maintaining the effect of suppressing the gate voltage Vg from diverging (falling behind) excessively, the gate voltage Vg is also made to follow the power source voltage Vp, with the result of suppressing the occurrence of overshoot in the output voltage Vout.

More specifically, in cases in which the diodes D1 and D2 have the same specifications and each has a forward voltage drop of Vf, then a difference between the power source voltage Vp and the gate voltage Vg will always be 2Vf or below as illustrated in FIG. 1B. Namely, the gate voltage Vg is clamped at (Vp−2Vf) or higher. As illustrated in FIG. 1B, after the power source voltage Vp has been switched on, the gate voltage Vg is maintained at approximately 0V before rising from a timing t1 when 2Vf is reached, thereby suppressing a gate-source voltage Vgs of the P-type MOS transistor QP3 from diverging (increasing) excessively.

In other words, since the gate voltage Vg of the P-type MOS transistor QP3 is supplied via the diodes D1, D2, the gate voltage Vg starts to move faster than the feedback action of the amplifier circuit 20, enabling a period T1 during which the gate voltage Vg is extremely low (approximately 0V) to be ended swiftly. Note that in the constant voltage generation circuit 10 according to the present exemplary embodiment, a relationship between the gate voltage Vg when in a steady state (a state in which the output voltage Vout has reached a target voltage) and the power source voltage Vp is set so as to satisfy the relationship of Equation 1 below.

Vg>(Vp−2Vf) (Equation 1)

Since power does not pass through the diodes D1, D2 as long as Equation 1 is satisfied, the overshoot suppression circuit 22 (the diodes D1, D2) do not affect normal operation of the constant voltage generation circuit 10.

Note that although an example has been given in the above exemplary embodiment in which two diodes configure the overshoot suppression circuit 22 is two, the number of diodes is not limited thereto. The number of diodes employed may be set as appropriate according to the design conditions and so on of the constant voltage generation circuit. However, the number of diodes configuring the overshoot suppression circuit 22 needs to be determined in consideration of a current value flowing in the P-type MOS transistor QP3 configuring the output transistor. Moreover, in principle, the overshoot suppression effect is reduced as the number of diodes increases, and so an upper limit for the number of diodes may be set based on permitted overshoot standards and the like.

1. A constant voltage generation circuit comprising:
a differential pair including a first transistor having a gate input with a reference voltage and a second transistor having a gate input with a signal corresponding to an output voltage;
an output transistor having a gate connected to a connection point between a drain of one transistor of the differential pair and a load of the one transistor, and configured to output the output voltage; and
a diode connected between the gate of the output transistor and a power source.

2. The constant voltage generation circuit of claim 1, further comprising:
a third transistor having a drain with common connection to a drain of the first transistor and configuring the load of the one transistor; and
a fourth transistor having a gate and a drain connected together with the drain also having a common connection to a drain of the second transistor,
wherein the gate of the output transistor is connected to a connection point between the first transistor and the third transistor.

3. The constant voltage generation circuit of claim 1, further comprising a plurality of diodes,
wherein a number of the plurality of diodes is set within a range in which a total forward voltage of the plurality of diodes is greater than a potential difference between the power source and the gate of the output transistor.

4. The constant voltage generation circuit of claim 2, further comprising a plurality of diodes,
wherein a number of the plurality of diodes is set within a range in which a total forward voltage of the plurality of diodes is greater than a potential difference between the power source and the gate of the output transistor.
